(19) United States
(12) Patent Application Publication
(10) Pub. No.: US 2004/0206739 A1
(43) Pub. Date: Oct. 21, 2004

(54) Mirror heater

(76) Inventor: Roger Kent Duance, Snowtown (AU)

Correspondence Address: Warn Burgess & Hoffmann, Suite 140, 691 North Squirrel Road, Auburn Hills, MI, 48326, US

(21) Appl. No.: 10/482,360

(22) PCT Filed: Jul. 9, 2002
(86) PCT No.: PCT/AU02/00906

(30) Foreign Application Priority Data
Jul. 9, 2001 (AU) PR 6204
Oct. 30, 2001 (AU) PR 8527

(51) Int. Cl. H05B 3/84; H05B 1/02

(52) U.S. Cl. 219/219; 219/492

(57) ABSTRACT

A heating device and method for de-icing or de-fogging the surface of a vehicle mirror. The device is activated upon ignition of the vehicle engine, and remains activated for a predetermined period of time. During the vehicle's journey the heater may be re-activated if the temperature of the mirror surface falls below a pre-set minimum threshold.

### TECHNICAL FIELD

This invention relates to mirrors and particularly automobile external mirrors and to methods for demisting or de-icing these mirrors.

### BACKGROUND TO THE INVENTION

External mirrors on automobiles are essential to allow the driver to view areas to the side and to the rear of the automobile while driving, and particularly, to see other vehicles approaching.

In certain climates, the clarity of the view provided by the mirror can be severely compromised by ice forming over the surface of the mirror or, by condensation forming on the mirror. In such instances, the safety of the driver and surrounding road users is compromised as the driver is unable to properly view these critical areas about the vehicle.

This problem has traditionally been addressed by providing a heating element within the mirror which upon manual activation by the driver begins to heat the mirror surface and remove any ice or condensation formed thereon. This however requires the intervention of the driver and may take the driver's attention away from driving the vehicle.

Some automatic electronic systems also exist, which sense when a mirror is iced or fogged, however, these systems can be unreliable and can be complex and costly to manufacture and install.

It would be advantageous if a method and apparatus were provided which would allow for automatic demisting and de-icing of external automobile mirrors to reduce the formation of ice or condensation on the mirrors, while reducing costs and complexity.

### SUMMARY OF THE INVENTION

According to a first aspect of the present invention, there is provided a vehicle mirror heating system comprising;

a vehicle mirror for mounting to a vehicle, the vehicle having an engine and an ignition line;

a heating element disposed adjacent a surface of the mirror; and

a heating control circuit for controlling the operation of the heating element, wherein in use, the control circuit activates the heating element for a first predetermined period of time upon ignition of the vehicle engine.

Preferably, the heating system will also comprise a temperature sensor for sensing the temperature of the surface of the mirror and for providing control signals to the heating control circuit to activate the heating element for a second predetermined period of time, after the first predetermined period of time has elapsed, when the temperature of the mirror surface falls below a minimum threshold.

Preferably, the temperature sensor is disposed behind the surface of the mirror and is preferably a thermistor.

Preferably, the heating system is powered by the vehicle ignition line.

According to a second aspect of the present invention, there is provided a method of de-fogging or de-icing a vehicle mirror, the method comprising;

activating a heating element disposed adjacent a surface of the vehicle mirror upon ignition of an engine of the vehicle; and

deactivating the heating element after a first predetermined period of time.

Preferably, the method further comprises sensing the temperature of the mirror surface and reactivating the heating element for a second predetermined period of time when the sensed temperature falls below a minimum threshold.

According to a third aspect of the present invention, there is provided a vehicle mirror heater for de-fogging or de-icing the surface of a vehicle mirror, the heater comprising a heating element for mounting adjacent the surface of the vehicle mirror of a vehicle having an engine and an ignition line; and

a heating control circuit for controlling operation of the heating element, wherein in use, the control circuit activates the heating element for a first predetermined period of time upon ignition of the vehicle engine.

Preferably, the vehicle mirror heater will also comprise a temperature sensor for mounting adjacent the surface of the vehicle mirror, to sense the temperature of the surface of the mirror and for providing control signals to the heating control circuit to activate the heating element for a second predetermined period of time, after the first predetermined period of time has elapsed, when the temperature of the mirror surface falls below a minimum threshold.

Preferably, the temperature sensor is a thermistor.

Preferably, the mirror heater is, in use, powered by the vehicle ignition line.

### BRIEF DESCRIPTION OF THE DRAWINGS

FIG. 1 shows a circuit layout of the heating control system of the present invention.

### DETAILED DESCRIPTION OF THE PREFERRED EMBODIMENT

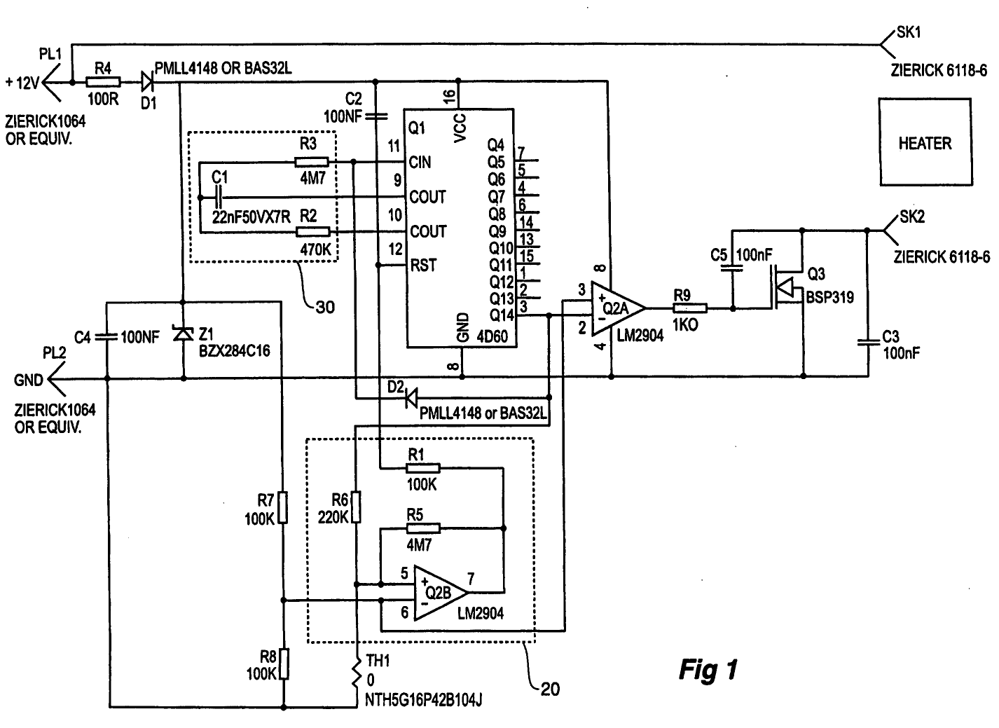

Referring now to FIG. 1, there is shown a circuit diagram of the heating control system of the present invention. Power to the circuit is provided by the vehicle ignition line (not shown), which is powered only when the vehicle engine is running. When the vehicle ignition line is powered, a positive voltage is provided to power line PL1, which provides a reset pulse to counter Q1 via capacitor C2. This reset pulse sets all Q1 outputs Q4 to Q14 to logic 0. When Q14 output is low, this enables an oscillator (30) formed by components R2, R3 and C1, via diode D2. Upon actuation of the oscillator 30, counter Q1 begins to count up.

A low output on Q14 also switches on heating element 10 via amplifier Q2A and via mosfet Q3.

The timing of the oscillator is set such that output Q14 goes high after the desired time period, for example 5 minutes. When Q14 goes high (ie when counter Q1 has counted out), it switches off both the oscillator (via diode D2) and the heater 10 (via amplifier Q2A and mosfet Q3).

When output Q14 goes high, this also enables thermistor circuit 20 by bringing thermistor divider resistor R6 to a logic 1. R6 and the negative temperature coefficient thermistor TH1 are chosen such that the thermistor resistance becomes equal to the resistance of R6 at the temperature selected for circuit activation. For example, the thermistor may be selected to be equal to the value of R6 at 5C. As the thermistor value rises above 220 K when the temperature falls below 5° C., the output from amplifier Q2B goes high and resets outputs Q4 to Q14 to low via resistor R1. In practice, thermistor TH1 will be mounted behind the mirror glass within the mirror housing. In this way, it can obtain a relatively accurate reading of the temperature of the mirror glass while being unobtrusive.

Counter Q1 then commences to count up as described above, causing heater 10 to actuate until the count period has expired, again as described above. As the temperature of the mirror increases, the thermistor value will drop below that of R6 causing the thermistor circuit to remain off until the temperature of the mirror surface has sufficiently dropped to again activate amplifier Q2B.

It is also desirable to provide to the driver an indication as to when the heater 10 is actually on. This may be provided by any convenient means, whether it be an audible indication or a visual indication such as an LED which is illuminated upon actuation of heater 10, and extinguished when heater 10 is turned off.

Feed-back resistor R5 provides a measure of hysteresis to the temperature such that the temperature must fall a little below 5° before the circuit activates and rise a little above 5° before it deactivates. This hysteresis prevents oscillation around the trigger point.

Diode D1 in power line PL1 provides for negative voltage isolation and resistor R4 and diode D1 guard against over voltage spikes as will be understood by the person skilled in the art. Capacitors C3, C4 and C5 provide further protection against voltage spikes and slow the output switching speed to reduce noise generated by the circuit.

The invention described herein provides a reliable and automatic method of demisting and/or de-icing external automobile mirrors. It will be understood that the invention has been described with reference to a particular preferred embodiment and that many other means of carrying out the invention are possible within the scope of the invention as will be understood by the person skilled in the art.

1. A vehicle mirror heating system comprising;
a vehicle mirror for mounting to a vehicle having an engine and an ignition line;
a heating element disposed adjacent a surface of the mirror; and
a heating control circuit for controlling the operation of the heating element, wherein, in use, the control circuit activates the heating element for a first predetermined period of time upon ignition of the vehicle engine:

2. A vehicle mirror heating system according to claim 1 further comprising a temperature sensor for sensing the temperature of the surface of the mirror and providing control signals to the heating control circuit to activate the heating element for a second predetermined period of time, after the first predetermined period of time has elapsed, when the temperature of the mirror surface falls below a minimum threshold.

3. A vehicle mirror heating system according to any one of claim 1 wherein the temperature sensor is disposed behind the surface of the mirror.

4. A vehicle mirror heating system according to claim 3 wherein the temperature sensor is a thermistor.

5. A vehicle mirror heating system according to any one of claim 1 wherein the heating system is powered by the vehicle ignition line.

6. A method of de-fogging or de-icing a vehicle mirror, the method comprising;
activating a heating element disposed adjacent a surface of the vehicle mirror upon ignition of an engine of the vehicle; and
deactivating the heating element after a first predetermined period of time.

7. A method of de-fogging or de-icing a vehicle mirror, according to claim 6, further comprising sensing the temperature of the mirror surface and reactivating the heating element for a second predetermined period of time when the sensed temperature falls below a minimum threshold.

8. A vehicle mirror heater for de-fogging or de-icing a surface of a vehicle mirror of a vehicle having an engine and an ignition line, the heater comprising;
a heating element for mounting adjacent the surface of the mirror; and
a heating control circuit for controlling the operation of the heating element, wherein, in use, the control circuit activates the heating element for a first predetermined period of time upon ignition of the vehicle engine.

9. A vehicle mirror heater according to claim 8, further comprising a temperature sensor for mounting adjacent the surface of the mirror, for sensing the temperature of the surface of the mirror and for providing control signals to the heating control circuit to activate the heating element for a second predetermined period of time, after the first predetermined period of time has elapsed, when the temperature of the mirror surface falls below a minimum threshold.

10. A vehicle mirror heater according to claim 9 wherein the temperature sensor is a thermistor.

11. A vehicle mirror heater according to claim 8 wherein the heater is powered by an ignition line of the vehicle.
